(19) United States
(12) Patent Application Publication
(10) Pub. No.: US 2019/0026925 A1
(43) Pub. Date: Jan. 24, 2019

(54) TEXTURE MAPPING APPARATUS AND COMPUTER READABLE MEDIUM

(71) Applicant: MITSUBISHI ELECTRIC CORPORATION, Tokyo (JP)

(72) Inventors: Satoshi SAKURAI, Tokyo (JP); Makoto OTSURU, Tokyo (JP); Hiroyasu NEGISHI, Tokyo (JP); Mitsuo SHIMOTANI, Tokyo (JP); Haruhiko WAKAYANAGI, Tokyo (JP); Takeshi SHIMIZU, Tokyo (JP)

(73) Assignee: MITSUBISHI ELECTRIC CORPORATION, Tokyo (JP)

(21) Appl. No.: 16/071,711

(22) PCT Filed: Mar. 15, 2016
(86) PCT No.: PCT/JP2016/058197

§ 371 Date: Jul. 20, 2018

(51) Int. Cl. G06T 11/00; G06T 11/20

(52) U.S. Cl. CPC G06T 11/001; G06T 11/203

(57) ABSTRACT

A first memory is a main memory that stores a texture image group. A second memory is a VRAM that stores a first texture atlas in which one or more texture images copied from the texture image group are arranged, and a second texture atlas to be newly generated. A texture copy section copies at least one of the texture images arranged in the first texture atlas from the first texture atlas to the second texture atlas.

### TECHNICAL FIELD

The present invention relates to texture mapping.

### BACKGROUND ART

In computer graphics, polygons are frequently used as primitives of drawing contents. In addition, in general, a two-dimensional image called a texture is mapped to a polygon in order to express the feel of material of drawing contents.

When a texture is mapped to a polygon, the polygon is drawn after the texture to be mapped is designated. In addition, it is known that a process to change a texture takes time. Therefore, if different textures are respectively mapped to a plurality of polygons, the processing time is prolonged.

As a method for solving this problem, a method is known in which a texture atlas combining a plurality of textures is prepared, and each texture included in the texture atlas is mapped onto a polygon. This method allows different textures to be respectively mapped to a plurality of polygons at high speed.

Patent Literature 1 discloses a method of dynamically generating a texture atlas at high speed and with low load.

However, when no more textures are put into the texture atlas, it is necessary to discard the texture atlas and generate a new texture atlas. Among textures included in the discarded texture atlas, a texture that is still to be used need be copied to the new texture atlas. Copying a texture means copying data from a main memory to a VRAM, but such copying is generally time consuming.

Further, a drawing process is often executed in a pipeline with many stages, but it is necessary to stop the pipeline when the texture atlas is discarded and a new texture atlas is generated. Therefore, the drawing speed decreases.

### CITATION LIST

### Patent Literature

Patent Literature 1: JP-A-2013-206094

### SUMMARY OF INVENTION

### Technical Problem

An object of the invention is to suppress a decrease in drawing speed in texture mapping.

### Solution to Problem

A texture mapping apparatus according to the invention includes:

a first storage section to store a texture image group which is one or more texture images;

a second storage section to store a first texture atlas in which the one or more texture images copied from the texture image group are arranged and a second texture atlas to be newly generated; and

a texture copy section to copy at least one of the texture images arranged in the first texture atlas from the first texture atlas to the second texture atlas.

### Advantageous Effects of Invention

According to the present invention, in a second storage section, texture images are copied from a first texture atlas to a second texture atlas.

As a result, the number of texture images to be copied from a texture image group in a first storage section to a second texture atlas in a second storage section is reduced.

Therefore, since the number of copies of texture images performed between the storage sections is reduced, it is possible to suppress a decrease in drawing speed.

### BRIEF DESCRIPTION OF DRAWINGS

FIG. 1 is a configuration diagram of a texture mapping apparatus 100 in a first embodiment.

FIG. 2 is a flowchart of a texture mapping method in the first embodiment.

FIG. 3 is a flowchart of a texture atlas generation process (S110) in the first embodiment.

FIG. 4 is a diagram illustrating a first arrangement information table 140 in the first embodiment.

FIG. 5 is a diagram illustrating a first texture atlas 170 in the first embodiment.

FIG. 6 is a flowchart of a texture mapping process (S120) in the first embodiment.

FIG. 7 is a diagram illustrating first mapping information data 150 in the first embodiment.

FIG. 8 is a diagram of a relationship between texture images 131 and textures 132 in the first embodiment.

FIG. 9 is a diagram illustrating second mapping information data 150 in the first embodiment.

FIG. 10 is a diagram illustrating a polygon image 160 in the first embodiment.

FIG. 11 is a flowchart of a texture copy process (S130) in the first embodiment.

FIG. 12 is a diagram illustrating a second arrangement information table 140 in the first embodiment.

FIG. 13 is a diagram illustrating third mapping information data 150 in the first embodiment.

FIG. 14 is a diagram illustrating a second texture atlas 170 in the first embodiment.

FIG. 15 is a hardware configuration diagram of the texture mapping apparatus 100 in the embodiment.

### DESCRIPTION OF EMBODIMENTS

### First Embodiment

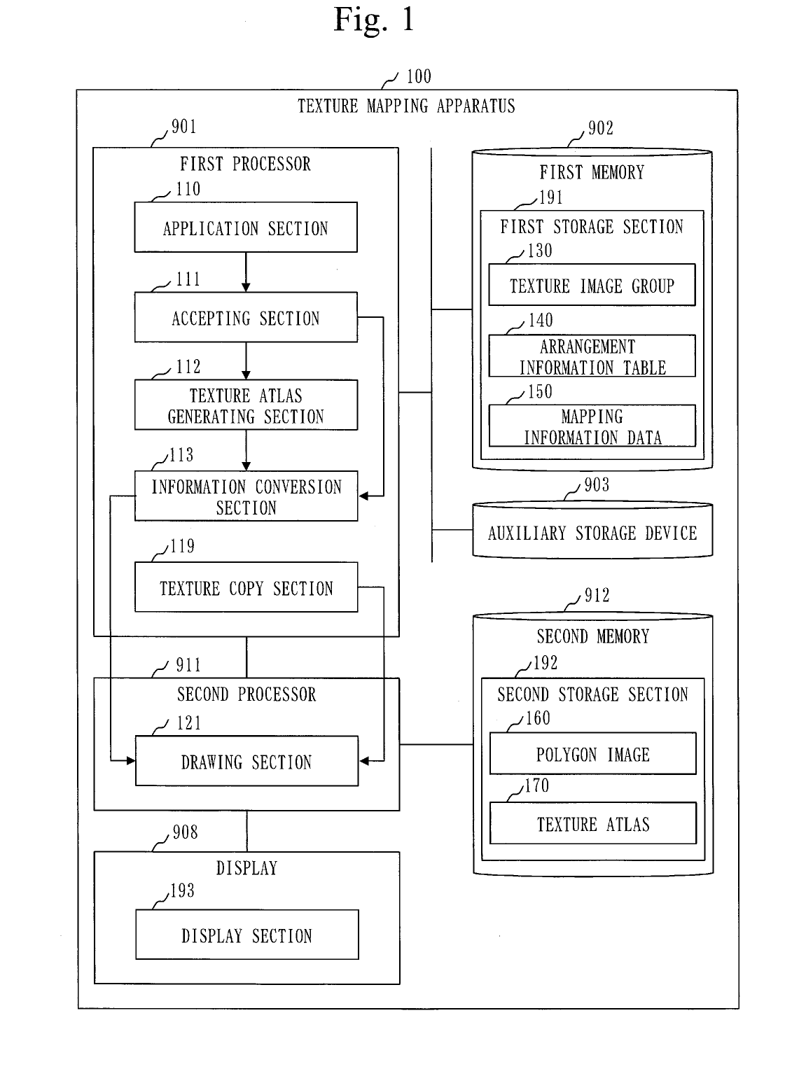

A texture mapping apparatus 100 will be described based on FIGS. 1 to 14.

***Description of the Configuration***

The configuration of the texture mapping apparatus 100 will be described based on FIG. 1.

The texture mapping apparatus 100 is a computer including hardware such as a first processor 901, a first memory 902, an auxiliary storage device 903, a second processor 911, a second memory 912, and a display 908.

The first processor 901 is connected to the first memory 902, the auxiliary storage device 903, and the second processor 911 via signal lines.

The second processor 911 is connected to the first processor 901, the second memory 912, and the display 908 via signal lines.

The first processor 901 and the second processor 911 are ICs (Integrated Circuits) that perform processing, and control other hardware. Specifically, the first processor 901 is a CPU and the second processor 911 is a GPU. CPU is an abbreviation of Central Processing Unit, and GPU is an abbreviation of Graphics Processing Unit.

The first memory 902 and the second memory 912 are volatile storage devices. Specifically, the first memory 902 is a main memory, and the second memory 912 is a VRAM (Video RAM). RAM is an abbreviation of Random Access Memory.

The auxiliary storage device 903 is a nonvolatile storage device. Specifically, the auxiliary storage device 903 is a ROM, an HDD or a flash memory. ROM is an abbreviation of Read Only Memory, and HDD is an abbreviation of Hard Disk Drive.

The display 908 is a display device for displaying data. Specifically, the display 908 is a liquid crystal display.

The texture mapping apparatus 100 includes “sections” such as an application section 110, an accepting section 111, a texture atlas generating section 112, an information conversion section 113, a texture copy section 119, and a drawing section 121 as function configuration elements. The functions of “sections” are achieved by software. The functions of “sections” will be described later.

Programs for achieving the functions of “sections” are stored in the auxiliary storage device 903. The programs for achieving the functions of “sections” are loaded into the first memory 902 and the second memory 912, and executed by the first processor 901 and the second processor 911.

Further, an OS (Operating System) is stored in the auxiliary storage device 903. At least a part of the OS is loaded into the first memory 902 and executed by the first processor 901.

That is, the first processor 901 executes the programs achieving the functions of “sections” while executing the OS.

Data obtained by executing the programs achieving the functions of “sections” are stored in storage devices such as the memory (902, 912), the auxiliary storage device 903, registers in the processors (901, 911) or cache memory in the processors (901, 911). These storage devices function as storage sections for storing data. The first memory 902 functions as a first storage section 191, and the second memory 912 functions as a second storage section 192.

Data used, generated, input/output, or transmitted/received by the texture mapping apparatus 100 are stored in the first memory 902 and the second memory 912.

Specifically, a texture image group 130, an arrangement information table 140, mapping information data 150 and the like are stored in the first memory 902. Further, a polygon image 160, a texture atlas 170 and the like are stored in the second memory 912. The contents of the data stored in the first memory 902 and the second memory 912 will be described later.

The display 908 functions as a display section 193 for displaying data.

Hardware including the first processor 901, the first memory 902 and the auxiliary storage device 903, and hardware including the second processor 911 and the second memory 912 are referred to as “processing circuitry”.

“Sections” may be read as “steps”, “processes”, or “procedures”. The functions of “sections” may be achieved by firmware.

The programs for achieving the functions of the “sections” can be stored in a nonvolatile storage medium such as a magnetic disk, an optical disk, a flash memory or the like.

***Description of Operation***

The operation of the texture mapping apparatus 100 corresponds to a texture mapping method. In addition, the procedure of the texture mapping method corresponds to the procedure of the texture mapping program.

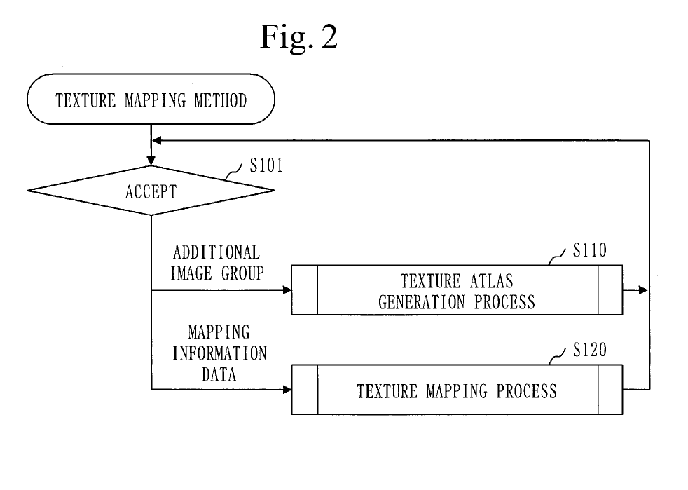

A texture mapping method will be described based on FIG. 2.

In step S101, the application section 110 outputs an additional image group or the mapping information data 150.

The application section 110 is a function of executing an application program for performing image processing on a polygon image 160.

The polygon image 160 is an image including a polygon 161 on which a texture 132 is drawn, and is displayed by the display section 193.

The additional image group is one or more texture images 131.

A texture image 131 is an image including one or more textures.

The mapping information data 150 is data including one or more pieces of mapping information 151.

The mapping information 151 includes polygon information 152, a texture image identifier 153, and texture information 154.

The polygon information 152 is information for specifying a portion in which the polygon 161 to be drawn is located in the polygon image 160.

The texture image identifier 153 is an identifier for identifying a texture image 131 including a texture 132 to be drawn.

The texture information 154 is information for specifying a portion in which the texture 132 to be drawn is included in the texture image 131 identified by the texture image identifier 153.

The accepting section 111 accepts the additional image group or the mapping information data 150 output from the application section 110.

When the additional image group is accepted, the first storage section 191 adds the additional image group to the texture image group 130, and the process proceeds to step S110.

When the mapping information data 150 is accepted, the first storage section 191 stores the mapping information data 150, and the process proceeds to step S120.

Step S110 is a texture atlas generation process.

In step S110, the texture atlas generating section 112 arranges the accepted additional image group in a first texture atlas 170.

The first texture atlas 170 is the texture atlas 170 in use, and is the texture atlas 170 in which one or more texture images 131 are arranged.

Details of the texture atlas generation process (S110) will be described later.

Step S120 is a texture mapping process.

In step S120, the drawing section 121 draws the texture 132 to be drawn on the polygon 161 to be drawn in the polygon image 160 using the accepted mapping information data 150.

Details of the texture mapping process (S120) will be described later.

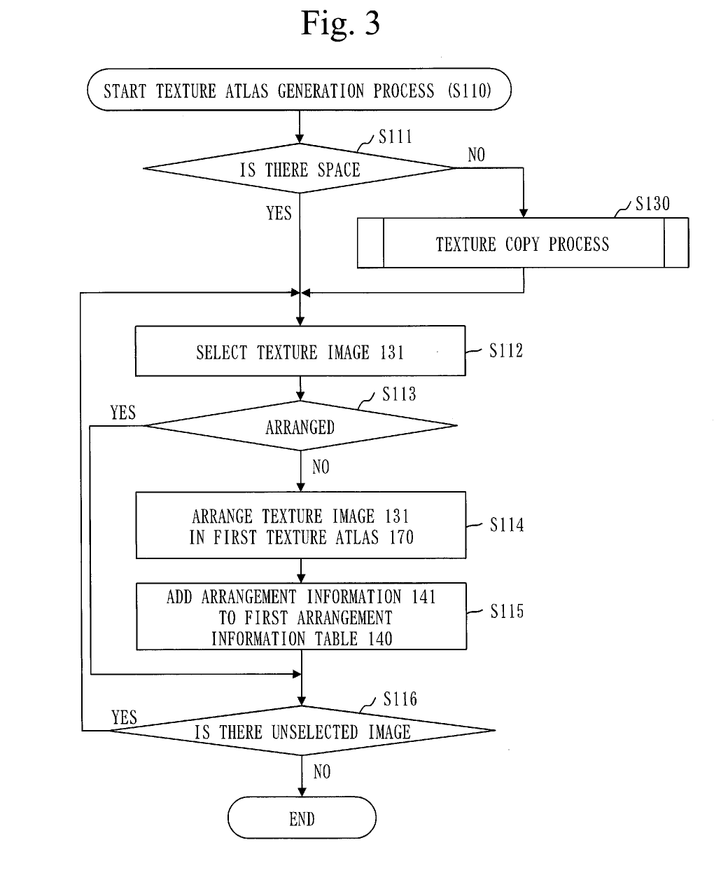

The procedure of the texture atlas generation process (S110) will be described based on FIG. 3.

In step S111, the texture atlas generating section 112 determines whether there is a necessary free space in the first texture atlas 170. The necessary free space is a free space necessary for arranging the accepted additional image group. The accepted additional image group is the additional image group accepted in step S101.

Specifically, the texture atlas generating section 112 determines whether there is a necessary free space as follows.

First, the texture atlas generating section 112 uses the first arrangement information table 140 to count the number of arrangements. The first arrangement information table 140 is the arrangement information table 140 corresponding to the first texture atlas 170. The number of arrangements is the number of texture images 131 arranged in the first texture atlas 170. The contents of the arrangement information table 140 will be described later.

Next, the texture atlas generating section 112 calculates the number of vacancies using the maximum number and the number of arrangements. The number of vacancies is obtained by subtracting the number of arrangements from the maximum number. The maximum number is the number of texture images 131 that can be arranged in a vacant texture atlas 170.

Then, the texture atlas generating section 112 compares the number of additional images with the number of vacancies. The number of additional images is the number of texture images 131 included in the accepted additional image group.

When the number of texture images 131 is larger than the number of vacancies, there is no necessary free space.

If there is a necessary free space, the process proceeds to step S112.

If there is no necessary free space, the process proceeds to step S130.

Step S130 is a texture copy process (S130).

In step S130, the texture copy section 119 generates a second texture atlas 170 and copies texture images 131 in the first texture atlas 170 to the second texture atlas 170.

The second texture atlas 170 is a new texture atlas 170.

After the texture images 131 in the first texture atlas 170 are copied to the second texture atlas 170, the first texture atlas 170 is deleted and the second texture atlas 170 is used as a first texture atlas 170.

Details of the texture copy process (S130) will be described later.

In step S112, the texture atlas generating section 112 selects one unselected texture image 131 from the accepted additional image group.

In step S113, the texture atlas generating section 112 determines whether the selected texture image 131 is already arranged in the first texture atlas 170.

This determination is made using the first arrangement information table 140.

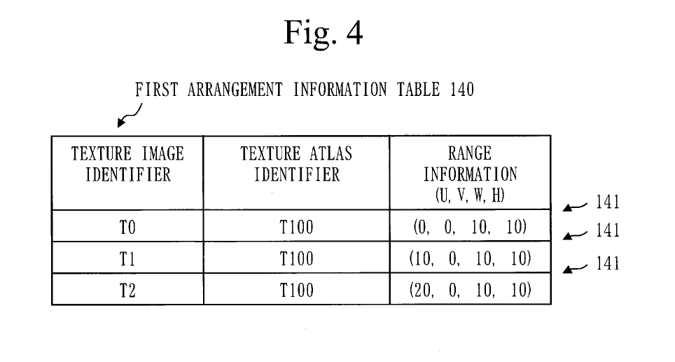

The first arrangement information table 140 will be described based on FIG. 4.

The first arrangement information table 140 is a table for managing a portion in which a texture image 131 is arranged for each of the texture images 131 arranged in the first texture atlas 170.

The first arrangement information table 140 includes arrangement information 141 for each of the texture images 131 arranged in the first texture atlas 170.

The arrangement information 141 includes a texture image identifier, a texture atlas identifier, and range information.

The texture image identifier identifies a texture image 131.

The texture atlas identifier identifies a first texture atlas 170.

The range information is information for specifying a portion in which a texture image 131 is arranged. Specifically, the range information includes a coordinate value (U, V) of a position where an upper left vertex of a texture image 131 is located, a width (W) of the texture image 131, and a height (H) of the texture image 131.

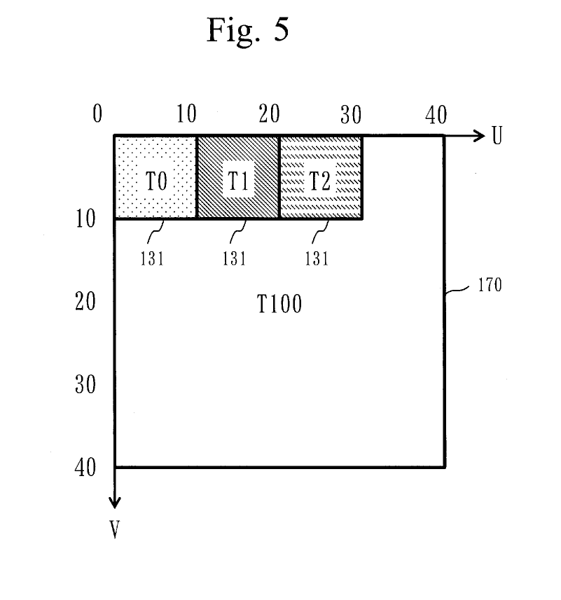

FIG. 5 illustrates a first texture atlas 170 corresponding to the first arrangement information table 140 in FIG. 4.

The first texture atlas 170 is identified by the identifier “T100”. The size of the first texture atlas 170 is 40×40 pixels.

A texture image 131 identified by the identifier “T0”, a texture image 131 identified by the identifier “T1”, and a texture image 131 identified by the identifier

“T2” are arranged in the first texture atlas 170. The size of each of the texture images 131 is 10×10 pixels.

Returning to FIG. 3, the description of step S113 will be continued.

Specifically, the texture atlas generating section 112 makes a determination as follows.

The texture atlas generating section 112 determines whether the same texture image identifier as the identifier of a selected texture image 131 is registered in the first arrangement information table 140. It is assumed that the identifier of a texture image 131 is attached to the texture image 131.

When the texture image identifier is registered in the first arrangement information table 140, the selected texture image 131 is already arranged in the first texture atlas 170.

If the selected texture image 131 is already arranged in the first texture atlas 170, the process proceeds to step S116.

If the selected texture image 131 is not arranged in the first texture atlas 170, the process proceeds to step S114.

In step S114, the texture atlas generating section 112 arranges the selected texture image 131 in the first texture atlas 170.

Specifically, the texture atlas generating section 112 operates as follows.

First, the texture atlas generating section 112 refers to the first arrangement information table 140 and determines an arrangement range from the free space of the first texture atlas 170. The determined arrangement range is a portion in which the selected texture image 131 is arranged. The arrangement range can be determined by an algorithm for solving a two-dimensional bin packing problem.

Then, the texture atlas generating section 112 delivers the selected texture image 131 and the range information to the drawing section 121. The delivered range information is information indicating the determined arrangement range.

Thereafter, the drawing section 121 draws the delivered texture image 131 in a portion indicated by the delivered range information in the first texture atlas 170.

As a result, the selected texture image 131 is arranged in the first texture atlas 170.

In step S115, the texture atlas generating section 112 adds the arrangement information 141 corresponding to the selected texture image 131 to the first arrangement information table 140.

Specifically, the texture atlas generating section 112 operates as follows.

First, the texture atlas generating section 112 generates arrangement information 141 including a texture image identifier, a texture atlas identifier, and range information.

The texture image identifier is the identifier of the selected texture image 131.

The texture atlas identifier is the identifier of the first texture atlas 170.

The range information is the range information delivered to the drawing section 121.

Then, the texture atlas generating section 112 adds the generated arrangement information 141 to the first arrangement information table 140.

In step S116, the texture atlas generating section 112 determines whether there is an unselected texture image 131 in the accepted additional image group.

If there is an unselected texture image 131, the process returns to step S112.

If there is no unselected texture image 131, the texture atlas generation process (S110) ends.

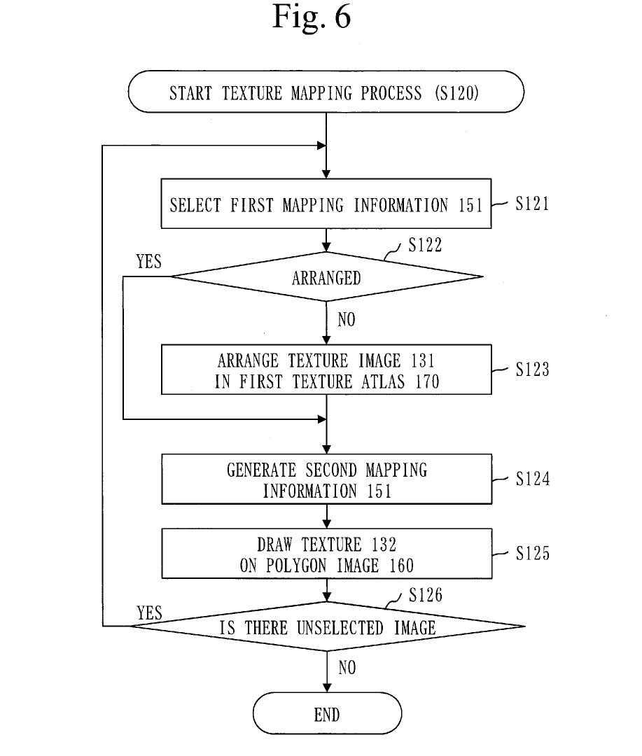

The procedure of the texture mapping process (S120) will be described based on FIG. 6.

In step S121, the information conversion section 113 selects one unselected first mapping information 151 from the first mapping information data 150.

The first mapping information data 150 is the mapping information data 150 accepted in step S101.

The first mapping information 151 is the mapping information 151 included in the first mapping information data 150.

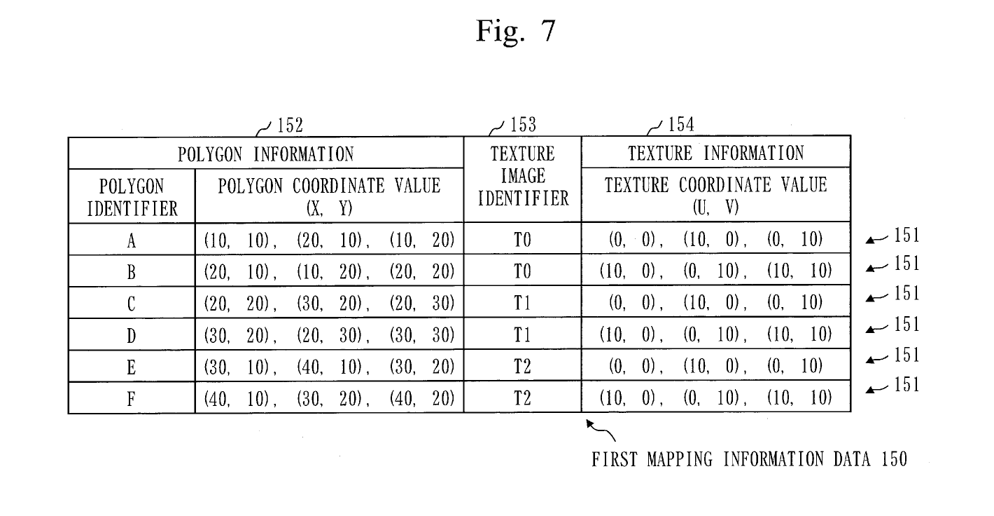

The first mapping information data 150 will be described based on FIG. 7.

The first mapping information data 150 includes one or more pieces of mapping information 151.

The first mapping information 151 includes polygon information 152, a texture image identifier 153, and texture information 154.

The polygon information 152 includes a polygon identifier and a polygon coordinate, and the texture information 154 includes a texture coordinate value.

The polygon identifier identifies a polygon 161.

The polygon coordinate value is a coordinate value of each vertex of the polygon 161. When the polygon 161 has a triangular shape, three sets of coordinate values are provided.

The texture image identifier 153 identifies a texture image 131.

The texture coordinate value is a coordinate value of each vertex of a texture 132.

When the texture 132 has a triangular shape, three sets of coordinate values are provided.

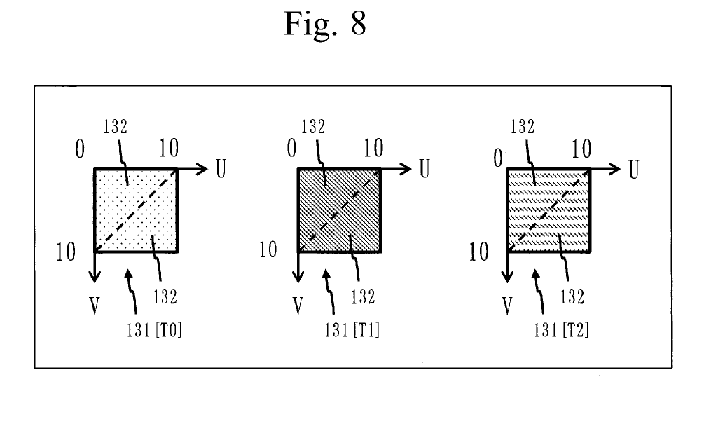

The relationship between texture images 131 and textures 132 will be described based on FIG. 8.

A texture image 131 includes one or more textures 132. Specifically, a quadrangular texture image 131 includes two triangular textures 132.

In FIG. 8, the texture image 131 of “T0”, the texture image 131 of “T1”, and the texture image 131 of “T2” are each a quadrangular texture image 131. Each texture image 131 includes two triangular textures 132.

Returning to FIG. 6, the description will be continued from step S122.

In step S122, the information conversion section 113 determines whether the texture image 131 corresponding to the selected first mapping information 151 is already arranged in the first texture atlas 170. The texture image 131 corresponding to the selected first mapping information 151 is the texture image 131 identified by the texture image identifier 153 included in the selected first mapping information 151.

Specifically, the information conversion section 113 determines whether the same texture image identifier 153 as the texture image identifier 153 included in the selected first mapping information 151 is registered in the first arrangement information table 140. When the texture image identifier 153 is registered in the first arrangement information table 140, the texture image 131 corresponding to the selected first mapping information 151 is already arranged in the first texture atlas 170.

If the texture image 131 corresponding to the selected first mapping information 151 is already arranged in the first texture atlas 170, the process proceeds to step S124.

If the texture image 131 corresponding to the selected first mapping information 151 is not arranged in the first texture atlas 170, the process proceeds to step S123.

In step S123, the texture atlas generating section 112 arranges the texture image 131 corresponding to the selected first mapping information 151 in the first texture atlas 170.

Specifically, the texture atlas generating section 112 executes the texture atlas generation process (S110) described based on FIG. 3. However, the object of the texture atlas generation process (S110) is the texture image 131 corresponding to the first mapping information 151 selected in step S121, not the additional image group accepted in S101.

In step S124, the information conversion section 113 generates second mapping information 151 corresponding to the selected first mapping information 151.

Like the selected first mapping information 151, the second mapping information 151 includes polygon information 152, a texture image identifier 153, and texture information 154.

The polygon information 152 included in the second mapping information 151 is the same as the polygon information 152 included in the selected first mapping information 151.

The texture image identifier 153 included in the second mapping information 151 is an identifier for identifying a first texture atlas 170.

The texture information 154 included in the second mapping information 151 is information for specifying a portion in which the texture 132 corresponding to the texture information 154 included in the selected first mapping information 151 is arranged in the first texture atlas 170. The texture 132 corresponding to the texture information 154 is the texture 132 existing in a portion specified by the texture information 154, in the texture image 131 identified by the texture image identifier 153.

Specifically, the information conversion section 113 generates the second mapping information 151 by changing the texture image identifier 153 and the texture information 154 in the selected first mapping information 151.

A texture coordinate value (U, V) that is the texture information 154 is changed as follows.

First, the information conversion section 113 acquires a texture image identifier from the selected first mapping information 151.

Next, the information conversion section 113 selects the arrangement information 141 including the same texture image identifier as the acquired texture image identifier 153 from the first arrangement information table 140.

Next, the information conversion section 113 acquires the coordinate value (U, V) from the range information included in the selected arrangement information 141.

Then, the information conversion section 113 adds the acquired coordinate value (U, V) to the texture coordinate value (U, V) included in the selected first mapping information 151.

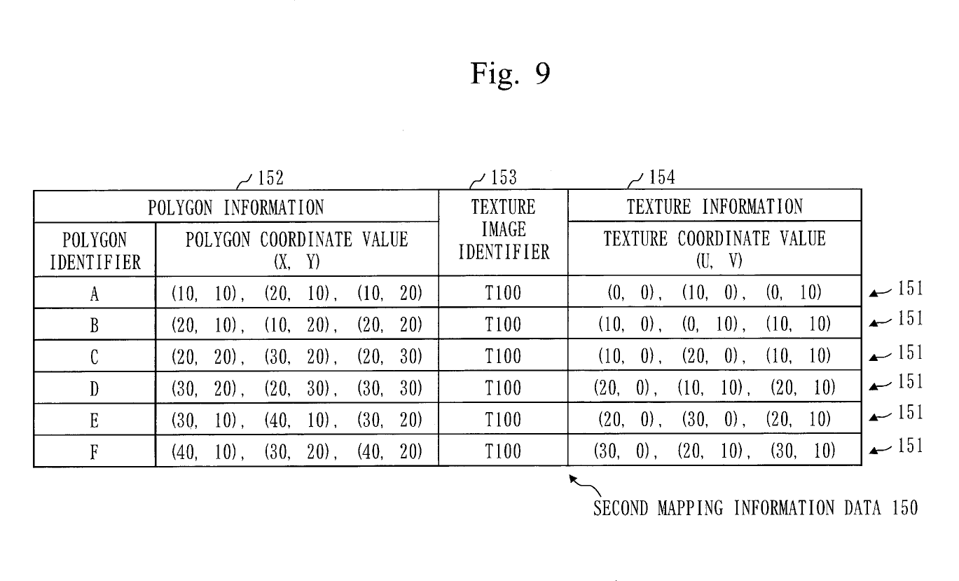

FIG. 9 illustrates second mapping information data 150 corresponding to the first mapping information data 150 in FIG. 7 and the first arrangement information table 140 in FIG. 4.

In the first mapping information data 150 in FIG. 7, the polygon identifiers corresponding to the texture image identifier “T0” are “A” and “B”. In the first arrangement information table 140 in FIG. 4, the coordinate value (U, V) corresponding to the texture image identifier “T0” is (0, 0). Therefore, in the second mapping information data 150 in FIG. 9, the texture coordinate value (U, V) corresponding to the polygon identifiers “A” and “B” is the same as the texture coordinate value (U, V) in the first mapping information data 150 in FIG. 7.

In the first mapping information data 150 in FIG. 7, the polygon identifiers corresponding to the texture image identifier “T1” are “C” and “D”. In the first arrangement information table 140 in FIG. 4, the coordinate value (U, V) corresponding to the texture image identifier “T1” is (10, 0). Therefore, in the second mapping information data 150 in FIG. 9, the texture coordinate value (U, V) corresponding to the polygon identifiers “C” and “D” is the value obtained by adding (10, 0) to the texture coordinate value (U, V) in the first mapping information data 150 in FIG. 7.

In the first mapping information data 150 in FIG. 7, the polygon identifiers corresponding to the texture image identifier “T2” are “E” and “F”. In the first arrangement information table 140 in FIG. 4, the coordinate value (U, V) corresponding to the texture image identifier “T2” is (20, 0). Therefore, in the second mapping information data 150 in FIG. 9, the texture coordinate value (U, V) corresponding to the polygon identifiers “E” and “F” is the value obtained by adding (20, 0) to the texture coordinate value (U, V) in the first mapping information data 150 in FIG. 7.

Returning to FIG. 6, the description of step S124 will be continued.

The information conversion section 113 delivers the second mapping information 151 to the drawing section 121.

In step S125, the texture image identifier 153 included in the second mapping information 151 identifies a first texture atlas 170.

Therefore, the drawing section 121 copies, from the first texture atlas 170, the texture 132 arranged in a portion specified by the texture information 154 included in the second mapping information 151.

Next, the drawing section 121 selects, from the polygon image 160, the polygon 161 located in a portion specified by the polygon information 152 included in the second mapping information 151.

Then, the drawing section 121 draws the texture 132 copied from the first texture atlas 170 on the polygon 161 selected from the polygon image 160.

In step S126, the information conversion section 113 determines whether there is an unselected first mapping information 151 in the first mapping information data 150.

If there is an unselected first mapping information 151, the process returns to step S121.

If there is no unselected first mapping information 151, the texture mapping process (S120) ends.

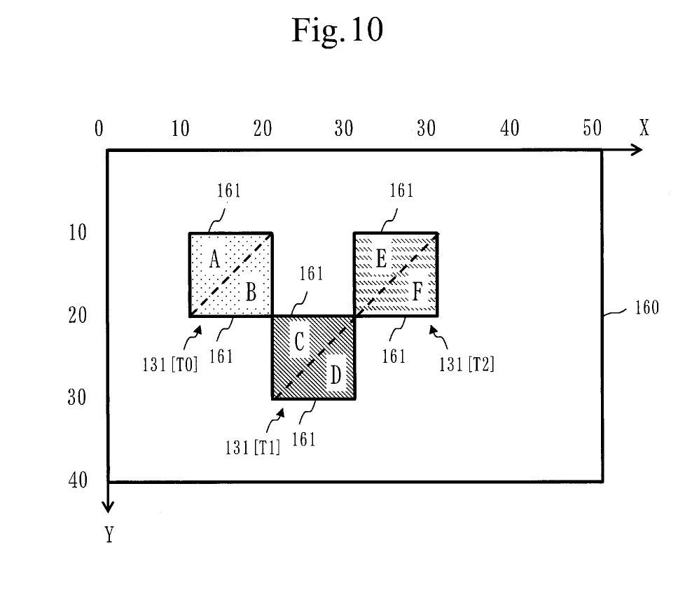

FIG. 10 illustrates a polygon image 160 corresponding to the second mapping information data 150 in FIG. 9. The size of the polygon image 160 is 50×40 pixels.

In the polygon image 160 in FIG. 10, texture images 131 corresponding to the texture information 154 in the second mapping information data 150 in FIG. 9 are drawn in the polygons 161 corresponding to the polygon information 152 in the second mapping information data 150 in FIG. 9.

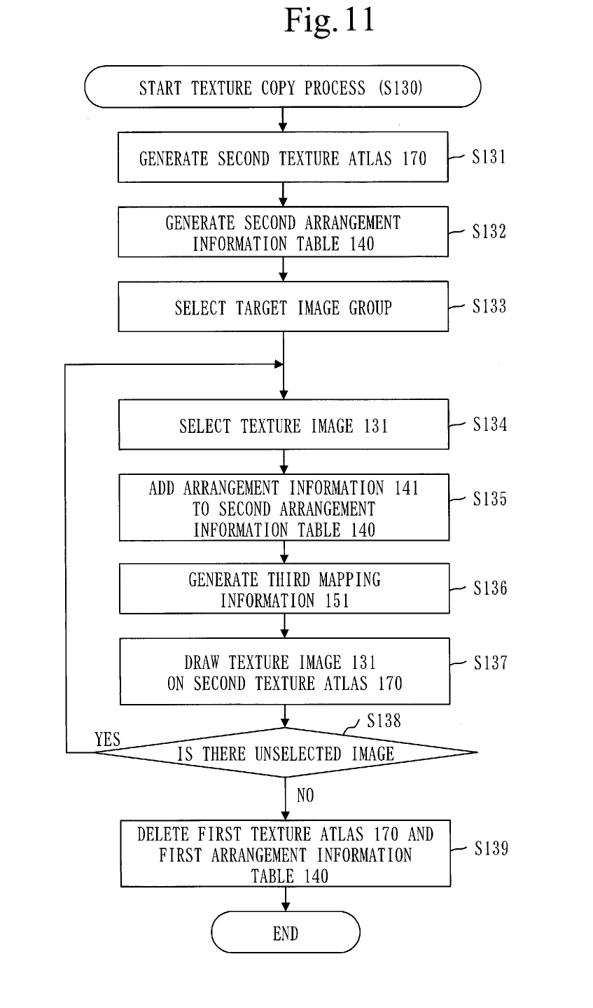

The procedure of the texture copy process (S130) will be described based on FIG. 11.

In step S131, the texture copy section 119 generates a second texture atlas 170.

Specifically, the texture copy section 119 requests the second processor 911 to acquire a storage area for the second texture atlas 170, and the second processor 911 acquires the storage area for the second texture atlas 170 in the second storage section 192.

In step S132, the texture copy section 119 generates a second arrangement information table 140.

The second arrangement information table 140 is an arrangement information table 140 corresponding to the second texture atlas 170.

Specifically, the texture copy section 119 acquires a storage area for the second arrangement information table 140 in the first storage section 191.

In step S133, the texture copy section 119 selects a target image group.

The target image group is one or more texture images 131 to be copied from the first texture atlas 170 to the second texture atlas 170.

Specifically, the application section 110 specifies a texture image group necessary for drawing. Then, from the specified texture image group, the texture copy section 119 selects one or more texture images 131 arranged in the first texture atlas 170 as a target image group.

In step S134, the texture copy section 119 selects one unselected texture image 131 from the target image group.

In step S135, the texture copy section 119 adds the arrangement information 141 corresponding to the selected texture image 131 to the second arrangement information table 140.

Specifically, the texture copy section 119 operates as follows.

First, the texture copy section 119 refers to the second arrangement information table 140 and determines an arrangement range from the free space of the second texture atlas 170. The determined arrangement range is a portion in which the selected texture image 131 is arranged. As in step S114, the arrangement range can be determined by an algorithm for solving a two-dimensional bin packing problem.

Next, the texture copy section 119 generates arrangement information 141 including a texture image identifier, a texture atlas identifier, and range information.

The texture image identifier is the identifier of the selected texture image 131.

The texture atlas identifier is the identifier of the second texture atlas 170.

The range information is information indicating the determined arrangement range.

Then, the texture copy section 119 adds the generated arrangement information 141 to the second arrangement information table 140.

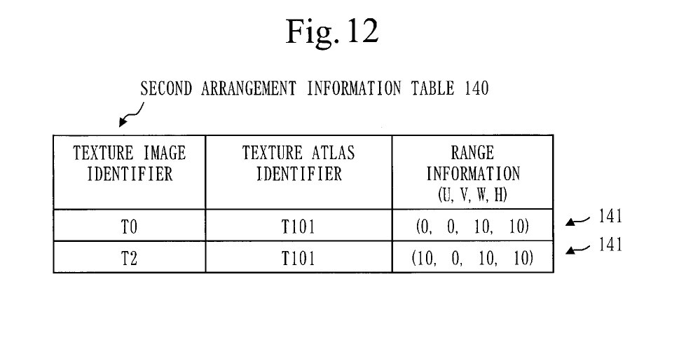

FIG. 12 illustrates the second arrangement information table 140 when the texture image 131 of “T0” and the texture image 131 of “T2” are in the target image group.

The second arrangement information table 140 in FIG. 12 includes arrangement information 141 including a texture image identifier “T0”, and arrangement information 141 including a texture image identifier “T2”.

In step S136, the texture copy section 119 generates third mapping information 151.

The third mapping information 151 is mapping information 151 corresponding to the selected texture image 131.

Like the first mapping information 151 and the second mapping information 151, the third mapping information 151 includes polygon information 152, a texture image identifier 153, and texture information 154.

The polygon information 152 included in the third mapping information 151 is information for specifying a part of the second texture atlas 170.

The texture image identifier 153 included in the third mapping information 151 is an identifier for identifying a first texture atlas 170.

The texture information 154 included in the third mapping information 151 is information for specifying a portion in which the texture 132 corresponding to the texture information 154 included in the first mapping information 151 is arranged in the first texture atlas 170.

Specifically, the texture copy section 119 generates the third mapping information 151 using the first arrangement information table 140 and the second arrangement information table 140.

When the texture image 131 has a quadrangular shape and the texture 132 has a triangular shape, the texture copy section 119 generates two pieces of third mapping information 151.

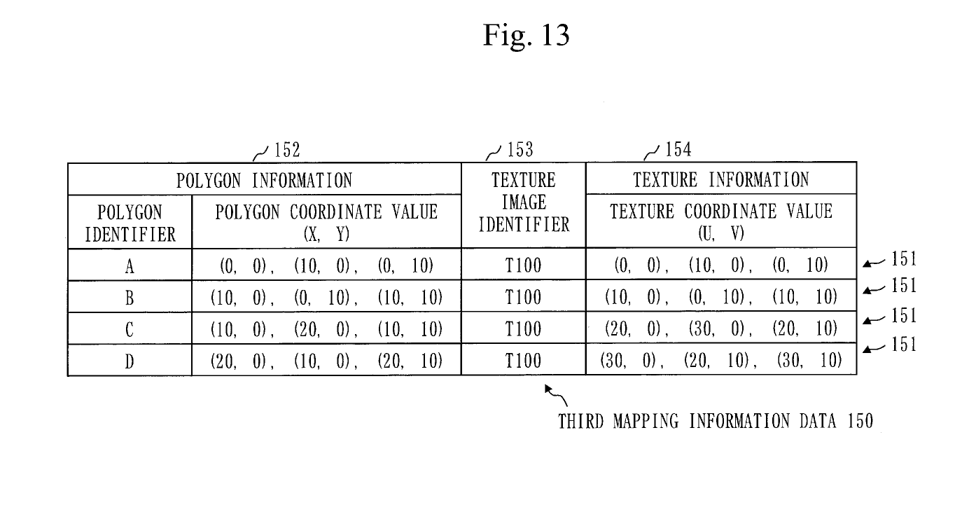

FIG. 13 illustrates third mapping information data 150 corresponding to the second arrangement information table 140 in FIG. 12 and the first arrangement information table 140 in FIG. 4.

A polygon identifier included in the polygon information 152 is an arbitrary identifier.

A polygon coordinate value included in the polygon information 152 is calculated as follows.

First, the texture copy section 119 calculates four coordinate values using the range information included in the arrangement information 141 in the second arrangement information table 140. The four coordinate values are coordinate values for each of the vertexes of the quadrangle formed by the arrangement range. When the range information (U, V, W, H) is (0, 0, 10, 10), the four coordinate values are (0, 0), (10, 0), (0, 10), and (10, 10).

Then, the texture copy section 119 selects two sets of three coordinate values using the four coordinate values. The two sets of three coordinate values are coordinate values for each of the vertexes of two triangles constituting a quadrangle formed by the arrangement range. In the above case, a set of (0, 0), (10, 0) and (0, 10), and a set of (10, 0), (0, 10) and (10, 10) are selected.

The three coordinate values to be selected are polygon coordinate values.

The texture image identifier 153 is the identifier of the second texture atlas 170.

The texture coordinate value which is the texture information 154 is calculated using the range information included in the arrangement information 141 in the first arrangement information table 140. The calculation method is the same as the method of calculating polygon coordinate values.

Returning to FIG. 11, the description of step S136 will be continued.

The texture copy section 119 delivers the third mapping information 151 to the drawing section 121.

In step S137, for each third mapping information 151 delivered from the texture copy section 119 to the drawing section 121, the drawing section 121 operates as follows.

The texture image identifier 153 included in the third mapping information 151 identifies a first texture atlas 170.

Therefore, the drawing section 121 copies, from the first texture atlas 170, the texture 132 arranged in a portion specified by the texture information 154 included in the third mapping information 151.

Next, the drawing section 121 selects a portion specified by the polygon information 152 included in the third mapping information 151 from the second texture atlas 170.

Then, the drawing section 121 draws the texture 132 copied from the first texture atlas 170 on a portion selected from the second texture atlas 170.

In step S138, the texture copy section 119 determines whether there is an unselected texture image 131 in the target image group.

If there is an unselected texture image 131, the process returns to step S134.

If there is no unselected texture image 131, the process proceeds to step S139.

In step S139, the texture copy section 119 deletes the first texture atlas 170 and the first arrangement information table 140 from the first storage section 191.

Thereafter, the second texture atlas 170 is used as a first texture atlas 170, and the second arrangement information table 140 is used as a first arrangement information table 140.

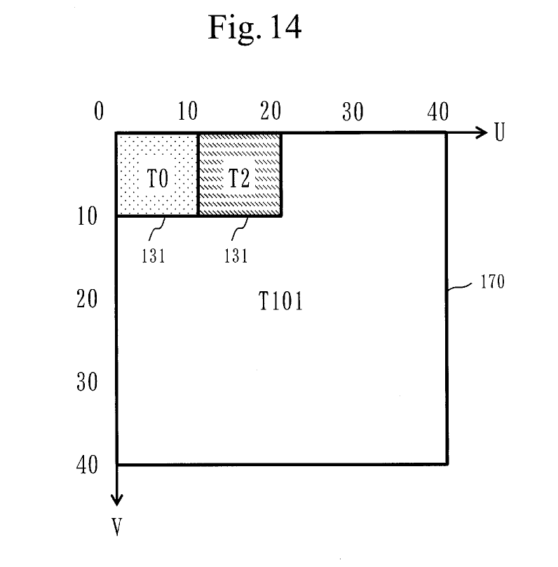

FIG. 14 illustrates a third texture atlas 170 corresponding to the third mapping information data 150 in FIG. 13.

In the third texture atlas 170 in FIG. 14, texture images 131 corresponding to the texture information 154 in the third mapping information data 150 in FIG. 13 are drawn on portions corresponding to the polygon information 152 in the third mapping information data 150 in FIG. 13.

***Effect of First Embodiment***

The texture image group 130 is stored in the first memory 902 that functions as the first storage section 191. Specifically, the first memory 902 is a main memory.

The texture atlas 170 is stored in the second memory 912 that functions as the second storage section 192. Specifically, the second memory 912 is a VRAM.

The time required to copy data in the VRAM is shorter than the time required to copy data from the main memory to the VRAM.

Therefore, when generating a new texture atlas 170, the texture mapping apparatus 100 copies some of the texture images 131 in the old texture atlas 170 to the new texture atlas 170.

As a result, the number of texture images 131 to be copied from the texture image group 130 in the main memory to the new texture atlas 170 in the VRAM is reduced.

This makes it possible to suppress a decrease in the speed of drawing the polygon image 160.

***Other Configurations***

The texture image 131 may have a shape other than a quadrangle.

One texture 132 or three or more textures 132 may be included in the texture image 131.

The texture 132 and the polygon 161 may have a shape other than a triangle.

Any method may be used for determining an arrangement range where the texture image 131 is arranged. That is, the arrangement range may be determined by an algorithm different from the algorithm for solving the two-dimensional bin packing problem.

A second texture atlas 170 which is a new texture atlas 170 may be generated at any time.

That is, the new texture atlas 170 may be generated at a timing other than when a free space in the first texture atlas 170 that is the old texture atlas 170 is insufficient.

Specifically, a new texture atlas 170 may be periodically generated. By periodically generating a new texture atlas 170, unnecessary texture images 131 can be excluded from the texture atlas 170.

A texture image 131 having a high degree of importance may be selected as the texture image 131 to be copied from the old texture atlas 170 (first texture atlas) to the new texture atlas 170 (second texture atlas).

Specifically, a texture image 131 with high use frequency may be selected.

A texture image 131 with high use frequency is determined as follows.

The application section 110 counts the number of uses for each texture image 131 using a use number table. The use number table is a table in which texture image identifiers are mutually associated with the number of uses, and is stored in the first storage section 191.

Specifically, when outputting the mapping information data 150, the application section 110 selects the number of uses associated with the same identifier as the texture image identifier 153 included in the mapping information data 150 from the use number table. Then, the application section 110 adds 1 to the selected number of uses.

The texture copy section 119 calculates the use frequency for each texture image 131 using the use number table. The use frequency is the percentage of the number of uses to the total number of uses.

Then, the texture copy section 119 compares use frequency for each texture image 131 with a frequency threshold.

The texture image 131 whose use frequency is higher than the frequency threshold is the texture image 131 with high use frequency.

Further, a texture image 131 with high possibility of being used may be selected. When a menu screen including a button is displayed, the texture image 131 with high possibility of being used is the texture image 131 representing the button.

The texture image 131 with high possibility of being used is determined as follows.

The first storage section 191 stores a predicted value table. The predicted value table is a table in which texture image identifiers are mutually associated with predicted values. A predicted value is a value indicating the degree of possibility of being used.

The texture copy section 119 compares a predicted value of each texture image 131 with a prediction threshold.

The texture image 131 whose predicted value is higher than the prediction threshold is the texture image 131 with high possibility of being used.

Two or more texture atlases 170 (first texture atlas) used for drawing may be used. In that case, when a new texture atlas 170 (second texture atlas) is generated, the texture atlas 170 to be discarded is selected. Then, the texture copy section 119 copies texture images 131 from the selected texture atlas 170 to the new texture atlas 170, and discards the selected texture atlas 170.

Any method may be used for selecting the texture atlas 170 to be discarded.

Specifically, the older texture atlas 170 may be selected.

Further, the texture atlas 170 having the less texture images 131 with high use frequency may be selected. The texture image 131 with high use frequency is determined using a frequency threshold as described above. The texture copy section 119 calculates the number of texture images 131 whose use frequency is higher than the frequency threshold for each texture atlas 170 and selects the texture atlas 170 with the smaller number of the calculated texture images 131.

Further, the texture atlas 170 having more texture images 131 with low use frequency may be selected. The texture image 131 with low use frequency is determined using predicted values and a prediction threshold as described above. The texture image 131 whose predicted value is lower than the prediction threshold is the texture image 131 with low possibility of being used. The texture copy section 119 calculates the number of texture images 131 whose predicted value is lower than the prediction threshold for each texture atlas 170 and selects the texture atlas 170 with the higher number of the calculated texture images 131.

The number of texture atlases 170 used for drawing may be dynamically changed. Specifically, the number of texture atlases 170 may be adjusted according to the memory usage of the VRAM. In that case, as the memory usage increases, the number of texture atlases 170 decreases.

A new texture atlas 170 may be of a different size than an old texture atlas 170.

Specifically, the size of the new texture atlas 170 may be adjusted according to the memory usage of the VRAM. In that case, as the memory usage increases, the size of the new texture atlas 170 decreases.

A new texture atlas 170 and an old texture atlas 170 may be arranged in one image. In that case, one image is divided into two regions, the new texture atlas 170 is arranged in one region, and the old texture atlas 170 is arranged in the other region. This eliminates the need to switch images for the texture atlas 170 when the texture atlas 170 used for drawing switches from the old texture atlas 170 to the new texture atlas 170. As a result, the time required for switching between the texture atlases 170 is shortened.

Texture images 131 may be rearranged in a texture atlas 170. Specifically, when the filling rate of the texture atlas 170 becomes high, another texture image 131 is arranged in a portion in which a texture image 131 with low use frequency is arranged. Thus, the filling rate of the texture atlas 170 can be suppressed. The filling rate is the proportion of the portion where texture images 131 are arranged.

***Supplement to the Embodiment***

In the embodiment, the function of the texture mapping apparatus 100 may be implemented by hardware.

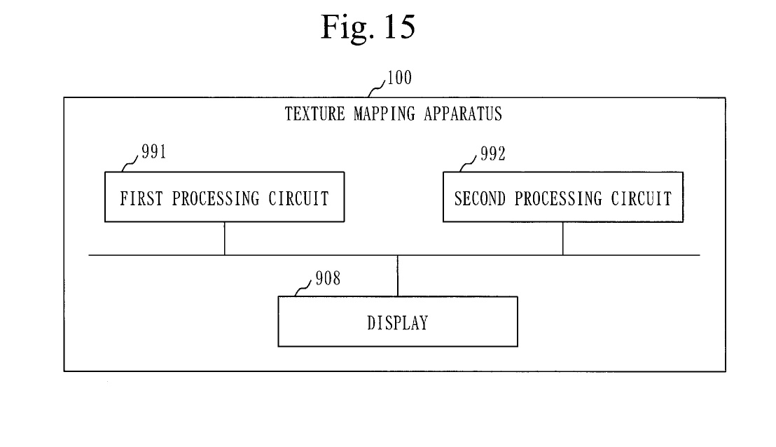

FIG. 15 illustrates the configuration when the function of the texture mapping apparatus 100 is implemented by hardware.

The texture mapping apparatus 100 includes a first processing circuit 991 and a second processing circuit 992. The first processing circuit 991 and the second processing circuit 992 are also referred to as processing circuitry.

The first processing circuit 991 is a dedicated electronic circuit for implementing the functions of “sections” such as the application section 110, the accepting section 111, the texture atlas generating section 112, the information conversion section 113, the texture copy section 119, and the first storage section 191.

The second processing circuit 992 is a dedicated electronic circuit for implementing the functions of “sections” such as the drawing section 121 and the second storage section 192.

Specifically, the first processing circuit 991 and the second processing circuit 992 are each a single circuit, a composite circuit, a programmed processor, a parallel-programmed processor, a logic IC, a GA, an ASIC, an FPGA, or a combination thereof. GA is an abbreviation of Gate Array, ASIC is an abbreviation of Application Specific Integrated Circuit, and FPGA is an abbreviation of Field Programmable Gate Array.

The function of the texture mapping apparatus 100 may be implemented by combining software and hardware. That is, a part of the “sections” may be implemented by software, and the rest of the “sections” may be implemented by hardware.

Since the embodiment illustrates a preferable mode, it does not intend to limit the technical scope of the invention. The embodiment may be practiced partially or may be combined with another embodiment. The procedure described using flowcharts and the like may be changed as appropriate.

### REFERENCE SIGNS LIST

100: texture mapping apparatus, 110: application section, 111: accepting section, 112: texture atlas generating section, 113: information conversion section, 119: texture copy section, 121: drawing section, 130: texture image group, 131: texture image, 132: texture, 140: arrangement information table, 141: arrangement information, 150: mapping information data, 151: mapping information, 152: polygon information, 153: texture image identifier, 154: texture information, 160: polygon image, 161: polygon, 170: texture atlas, 191: first storage section, 192: second storage section, 193: display section, 901: first processor, 902: first memory, 903: auxiliary storage device, 908: display, 911: second processor, 912: second memory, 991: first processing circuit, 992: second processing circuit.

1. A texture mapping apparatus comprising:
first processing circuitry
to store a texture image group which is one or more texture images, and
second processing circuitry
to store a first texture atlas in which the one or more texture images copied from the texture image group are arranged and a second texture atlas to be newly generate,
wherein the first processing circuitry copies at least one of the texture images arranged in the first texture atlas from the first texture atlas to the second texture atlas.

2. The texture mapping apparatus according to claim 1,
wherein each of the texture images is an image including one or more textures,
the second processing circuitry
stores a polygon image including polygons on which textures are drawn,
the first processing circuitry
accepts first mapping information including polygon information that specifies a portion in which a polygon to be drawn is located in the polygon image, a texture image identifier that identifies a texture image including a texture to be drawn, and texture information that specifies a portion including the texture to be drawn in the texture image identified by the texture image identifier,
arranges the texture image in the first texture atlas when the texture image identified by the texture image identifier included in the first mapping information is not arranged in the first texture atlas, and
generates second mapping information including the same polygon information as the polygon information included in the first mapping information, an identifier that identifies the first texture atlas as the texture image identifier, and information that specifies a portion in which the texture corresponding to texture information included in the first mapping information is arranged in the first texture atlas, as texture information, and
the second processing circuitry
draws the texture arranged in the portion specified by the texture information included in the second mapping information among the textures included in the first texture atlas identified by the texture image identifier included in the second mapping information on a polygon located in a portion specified by the polygon information included in the second mapping information among the polygons included in the polygon image.

3. The texture mapping apparatus according to claim 2,
wherein the first processing circuitry generates third mapping information including information that specifies a part of the second texture atlas as polygon information, an identifier that identifies the first texture atlas as the texture image identifier, and information that specifies a portion in which the texture corresponding to texture information included in the first mapping information is arranged in the first texture atlas, as texture information, and
second processing circuitry draws the texture arranged in the portion specified by the texture information included in the third mapping information among the textures included in the first texture atlas identified by the texture image identifier included in the third mapping information, on a portion specified by the polygon information included in the third mapping information, in the second texture atlas.

4. The texture mapping apparatus according to claim 3,
wherein the first processing circuitry determines the portion specified by the polygon information included in the third mapping information by an algorithm to solve a bin packing problem.

5. The texture mapping apparatus according to claim 1,
wherein the first processing circuitry copies a texture image whose use frequency is higher than a frequency threshold among the texture images arranged in the first texture atlas from the first texture atlas to the second texture atlas.

6. The texture mapping apparatus according to claim 1,
wherein the first processing circuitry copies a texture image whose predicted value indicating the degree of possibility of being used is higher than a prediction threshold among the texture images arranged in the first texture atlas from the first texture atlas to the second texture atlas.

7. The texture mapping apparatus according to claim 1,
wherein the second processing circuitry stores a plurality of first texture atlases, and
the first processing circuitry calculates a number of texture images whose use frequency is higher than a frequency threshold for each of the first texture atlases, selects a first texture atlas with a smaller number of the calculated texture images, copies texture images from the selected first texture atlas to the second texture atlas, and discards the selected first texture atlas.

8. The texture mapping apparatus according to claim 1,
wherein the second processing circuitry stores a plurality of first texture atlases, and
the first processing circuitry calculates a number of texture images whose predicted value indicating the degree of possibility of being used for each of the first texture atlases is lower than a prediction threshold, selects a first texture atlas with a larger number of the calculated texture images, copies texture images from the selected first texture atlas to the second texture atlas, and discards the selected first texture atlas.

9. A non-transitory computer readable medium storing a texture mapping program to cause a computer including a first memory and a second memory to function,
wherein the first memory is a memory that stores a texture image group which is one or more texture images, and
the second memory is a memory that stores a first texture atlas in which one or more texture images copied from the texture image group are arranged and a second texture atlas to be newly generated,
the texture mapping program causing the computer to execute a texture copy process that copies at least one of the texture images arranged in the first texture atlas from the first texture atlas to the second texture atlas.
